(19) United States
(12) Patent Application Publication
(10) Pub. No.: US 2026/0180606 A1
(43) Pub. Date: Jun. 25, 2026

(54) FORMING A SHIELD AROUND A DISPLAY FOR IMPROVED RECEIVER RADIATED SENSITIVITY

(71) Applicant: MOTOROLA SOLUTIONS, INC., Chicago, IL (US)

(72) Inventors: Ariel L. Galan, Miami, FL (US); Steven Gilmore, Coral Springs, FL (US); Musen Ji, Parkland, FL (US); Salvador P. Magana, Wellington, FL (US)

(21) Appl. No.: 18/999,333

(22) Filed: Dec. 23, 2024

(51) Int. Cl. H04B 1/12; H01Q 1/24; H04B 1/08

(52) U.S. Cl. CPC H04B 1/12; H01Q 1/241; H04B 1/086

(57) ABSTRACT

Examples provide a portable radio including a controller, a transceiver, an antenna connected to the transceiver, and a display emitting noise that interferes with a signal of the antenna. The display includes an indium tin oxide (ITO) layer disposed on the display and a bezel tray within which the display is positioned, the bezel tray having a bottom surface and a side opening. The display includes a flex circuit having a ground contact connected to the bottom surface and coupled to a radio chassis ground of the portable radio, and a conductive tape disposed on a top perimeter of the ITO layer, the conductive tape wrapping across the side opening to the bottom surface to form a gap, the ITO layer grounded through the conductive tape, the conductive tape and the ITO layer form a shield around the display to reduce the noise emitted from the display.

### BACKGROUND

Examples described herein relate to electromagnetic shielding of components of portable radios. Portable radios transmit and receive radio frequency signals within a variety of bandwidths. The components of the portable radio emit noise that may interfere with the radio frequency signals.

### BRIEF DESCRIPTION OF THE DRAWINGS

FIG. 1 is a block diagram of a radio, according to some examples.

FIG. 2A illustrates a radio including a display, according to some examples.

FIG. 2B illustrates a radio including a display, according to some examples.

FIG. 3 illustrates a display for a radio including an indium tin oxide (ITO) layer, according to some examples.

FIG. 4 is a side view of a display for a radio including an ITO layer and conductive tape, according to some examples.

FIG. 5 illustrates a display for a radio including an ITO layer and conductive tape positioned in a metal bezel tray, according to some examples.

FIG. 6 illustrates a display for a radio and an ITO layer with conductive tape separate from the display, according to some examples.

FIG. 7 illustrates a display for a radio including conductive tape having a conductive tab wrapping across the display, according to some examples.

FIG. 8 is a graph of radiated sensitivity per frequency for a radio, according to some examples.

FIG. 9 is a graph of radiated sensitivity per frequency for a radio, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the

disclosure with details that will be readily apparent to those of ordinary skill in the art having the benefit of the description herein.

### DETAILED DESCRIPTION

Portable radios, otherwise referred to herein as radios for simplicity, enable communication over a variety of radio bands, or radio frequency (RF) bandwidths. In some instances, a portable radio is a land mobile radio (LMR) configured for two-way communication

over an LMR communication system. When performing device-to-device communication over long distances of, for example, 6-7 miles, portable radios may transmit and receive signals within a very high frequency (VHF) radio band (e.g., 136-174 megahertz (MHz)). However, the VHF radio band is susceptible to noise coupling due to spectral proximity to frequencies of clocks and other signal sources commonly used and internally generated in electronic components of the

portable radio such as, for example, digital sections, microprocessors, and displays. Other noise is typically present in radio communication systems such as thermal noise, environmental noise, and semiconductor noise. In some instances, traditional portable radios shield critical radio receiver components from environmental noise, digital noise sources, and semiconductor noise.

RF noise emitted by the electronic components of the portable radio interferes with the VHF radio receiver band that the portable radio operates within. Since the required communication distance of the portable radio is very large, it is beneficial to minimize the amount of noise coupled into a radio receiver from internal electronic components outside the radio receiver such that the desired signal is discernable from the emitted noise. In the case of portable radios operating in the VHF radio band, the RF noise emitted from the electronic components of the portable radio may violate a signal-to-noise ratio (SNR) threshold for the portable radio. In such cases, the portable radio does not achieve an expected range performance within the VHF band and the emitted RF noise interrupts the signal. Thus, there is a need for a

portable radio including additional grounding and shielding to reduce RF noise emitted from the electronic components of the portable radio to a level below a noise floor to maintain sensitivity of the portable radio.

One example provides a portable radio that includes a housing having a display. The display forms part of a display module, the display module generates radio frequency (RF) noise greater than a receiver noise floor within a very high frequency (VHF) radio band. The portable radio includes a controller and a VHF narrowband transceiver operating within the housing. An external VHF antenna is operatively coupled to the VHF narrowband transceiver. The VHF antenna is susceptible to interference from the RF noise that is greater than the receiver noise floor. In one example, the display module includes a liquid crystal display (LCD) having a front glass surface. At least a portion of the front glass surface is viewable on the housing. An indium tin oxide (ITO) layer is disposed on the front glass surface. A top polarizer layer is disposed on the ITO layer. The top polarizer is retracted to form an exposed perimeter portion of the ITO layer. A display driver is coupled to a rear glass surface of the LCD. The LCD is seated within a metal bezel tray. The metal bezel tray includes a top opening and is formed of four metal sidewalls and a bottom metal surface. The metal bezel tray has a side opening in one of the sidewalls. A flex circuit is coupled to the display driver. The flex circuit has a flex ground point. The flex ground point is coupled to a radio chassis ground of the portable radio. A conductive adhesive tape adheres to the exposed perimeter portion of the ITO layer. The conductive adhesive tape covers all sides of the display driver. The conductive adhesive tape has a conductive tab extending therefrom. The conductive tab wraps across the side opening of the metal bezel and adheres to the bottom metal surface of the metal bezel. The conductive tab provides a first gap and a second gap. The flex circuit protrudes through the first gap to mate with the bottom metal surface of the metal bezel. The ITO layer is grounded through the conductive adhesive tape. The conductive adhesive tape forms a ground (GND) shield around the ITO layer, the display driver, and the flex circuit.

In some aspects, the ITO layer and the conductive adhesive tape reduce the RF noise below the receiver noise floor.

In some aspects, the VHF antenna and the VHF narrowband transceiver operate in a VHF radio band of 136-174 megahertz (MHz).

In some aspects, the second gap accommodates a light guide flex circuit for coupling a light guide of the display module to the controller.

In some aspects, the first gap accommodates a driver flex circuit for coupling the flex circuit of the display module to the display driver.

In some aspects, the ITO layer and the conductive adhesive tape reduce a leaked RF noise level from the display module below a 0.18 uVrms radiated sensitivity level of the VHF

narrowband transceiver, equivalent to a 7 mile line-of-sight coverage range.

In some aspects, the ITO layer and the conductive adhesive tape reduce the RF noise to a level of greater than 5 decibels (dB) below the receiver noise floor.

In some aspects, the first gap and the second gap are sized to block the RF noise through the side opening of the metal bezel tray.

In some aspects, the ITO layer is transparent such that the front glass surface is viewable on the housing.

In some aspects, the flex circuit is coupled to the display driver through the rear glass surface using an anisotropic conductive film (ACF).

In some aspects, the conductive adhesive tape covering all sides of the display driver includes the conductive adhesive tape covering a top surface of the display driver and a total area of the rear glass surface where the display driver is coupled.

In some aspects, the LCD is a six-sided LCD with the front glass surface, the rear glass surface, a first side surface, a second side surface, a third side surface, and a fourth side surface.

In some aspects, the display module includes a bottom polarizer layer disposed on the rear glass surface and a light guide coupled to the bottom polarizer layer.

Another example provides a portable radio that includes a housing having a controller and a very high frequency (VHF) transceiver operating within the housing. A VHF antenna is coupled to the housing and communicatively connected to the VHF transceiver. A display emits radio frequency (RF) noise greater than a receiver noise floor within a VHF radio band that

interferes with a radio signal of the VHF antenna. The display includes a display glass surface viewable on the housing. An indium tin oxide (ITO) layer is disposed on the display glass surface. The display glass surface is positioned within a metal bezel tray. The metal bezel tray has a top opening, four sides, and a bottom surface. The metal bezel tray has a side opening in one of the four sides. A flex circuit is coupled to a display driver. The flex circuit has a ground contact. The ground contact is connected to the bottom surface and is coupled to a radio chassis ground of the portable radio. A conductive tape is disposed on a top perimeter of the ITO layer. The conductive tape wraps across the side opening and couples to the bottom surface to form a gap between the bottom surface and the conductive tape. The ITO layer is grounded through the conductive tape. The conductive tape and the ITO layer form a shield around the display to reduce the RF noise emitted from the display.

In some aspects, the ITO layer and the conductive tape reduce the RF noise below the receiver noise floor.

In some aspects, the VHF antenna and the VHF transceiver operate in a VHF radio band of 136-174 megahertz (MHz).

In some aspects, the ITO layer and the conductive tape reduce a leaked RF noise level from the display module below a 0.18 uVrms radiated sensitivity level of the VHF transceiver, equivalent to a 7 mile line-of-sight coverage range.

In some aspects, the ITO layer and the conductive tape reduce the RF noise to a level of greater than 5 decibels (dB) below the receiver noise floor.

In some aspects, the gap includes a first gap and a second gap. The first gap and the second gap are sized to block the RF noise through the side opening of the metal bezel tray.

In some aspects, the ITO layer is transparent such that the display glass surface is viewable on the housing.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the FIG.

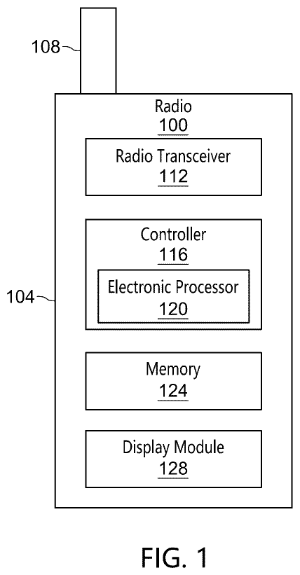

Referring now to the drawings, FIG. 1 schematically illustrates a radio 100, according to some examples. For simplicity, the radio 100 is illustrated and described herein as a standalone device. However, the radio 100 may be operable to transmit and receive radio signals between a plurality of radios over a communication system according to one or more communication protocols. In the illustrated example, the radio 100 is a portable (e.g., mobile) radio configured to communicate with other radios over a radio frequency (RF) network (e.g., a land mobile radio (LMR) network). In some examples, the radio 100 transmits and receives signals within a very high frequency (VHF) radio band (e.g., RF range) of between 136-174 megahertz (MHz). Although described herein as operating with respect to the VHF radio band, the radio 100 may transmit and receive signals over one or more radio bands.

In operation, the radio 100 is spaced a distance apart from another radio within a communication system. Accordingly, the radio 100 transmits and receives radio signals that propagate over the distance within the VHF radio band. The radio 100 may transmit and receive radio signals according to one or more suitable communication protocols. For example, in the VHF radio band, the radio 100 may operate according to the Project 25(P 25 ) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, and Analog FM per TIA603 standards. Outside the VHF radio band, the radio 100 may operate per LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, among other possibilities.

The radio 100 includes a housing 104 and an antenna 108 coupled to the housing 104. In the illustrated example, the antenna 108 is an external VHF antenna (or VHF antenna) configured to operate within the VHF radio band. The radio 100 also includes a radio transceiver (e.g., a VHF narrowband transceiver or VHF transceiver) 112 operating within the housing 104. The antenna 108 is operatively coupled (or communicatively connected) to the radio transceiver 112. The radio transceiver 112 includes a receiver circuit and a transmitter circuit configured to transmit and receive radio signals via the antenna 108. The radio 100 also includes a controller (e.g., an electronic controller) 116 having an electronic processor 120 (i.e., one or more electronic processors 120) configured to control operation of the radio 100. A memory 124 stores information related to operation of the radio 100, such as software or program instructions that, when executed by the electronic processor 120, cause the electronic processor 120 to perform, among other things, some or all of the control operations described herein.

The radio 100 also includes a display module 128 having a display forming part of the display module 128. The display of the display module 128 is viewable on the housing 104. The display module 128 is configured to display information related to the operation of the radio 100 via the display. In some examples, the display module 128 generates digital noise that

couples into the radio transceiver 112 (also referred to hereinafter as RF noise) and is greater than a total noise floor of the radio receiver components of radio 100, which is composed of thermal, environmental, and semiconductor noise within the VHF radio band. A receiver noise floor is a level of noise that is a threshold for interfering with radio signals. For example, an amount of generated RF noise that is greater than the receiver noise floor will interfere with radio signals received via the antenna 108. In other words, the antenna 108 is susceptible to interference from the RF noise that is greater than the receiver noise floor.

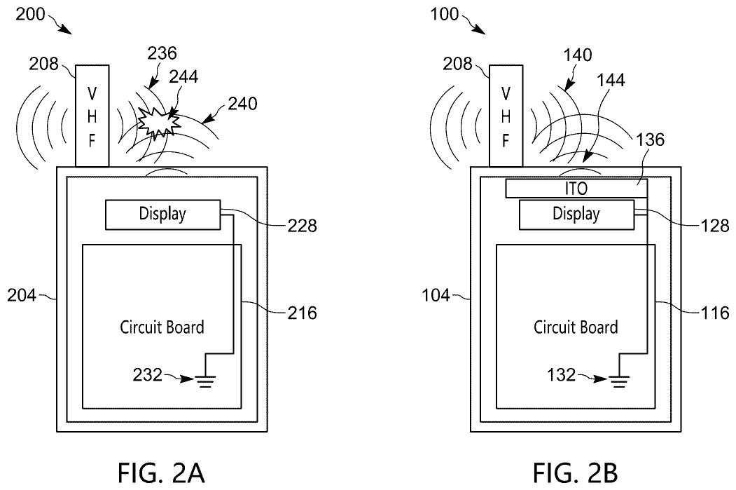

For example, FIG. 2A illustrates a radio 200 including a display 228, according to some examples. Similar to the radio 100 of FIG. 1, the radio 200 includes a housing 204, an antenna 208, and a controller 216 (also labelled as a circuit board, for simplicity). The display 228 is connected to the controller 216 and grounded via the controller 216 at a ground contact 232. In the illustrated example of FIG. 2A, the antenna 208 receives a radio signal 236 and the display 228 generates RF noise 240 that is greater than the receiver noise floor. As a visual representation in FIG. 2A, the RF noise 240 creates an interference 244 (e.g., an electromagnetic signal in the VHF band that interferes with the radio signal 236). Based on the interference 244 from the RF noise 240, a range performance of the radio 200 is reduced. In other words, the difference between the desired received signal level and the RF noise 240 (e.g., the SNR) is reduced such that the radio 100 does not adequately receive the radio signal 236 thereby reducing communication distance or range.

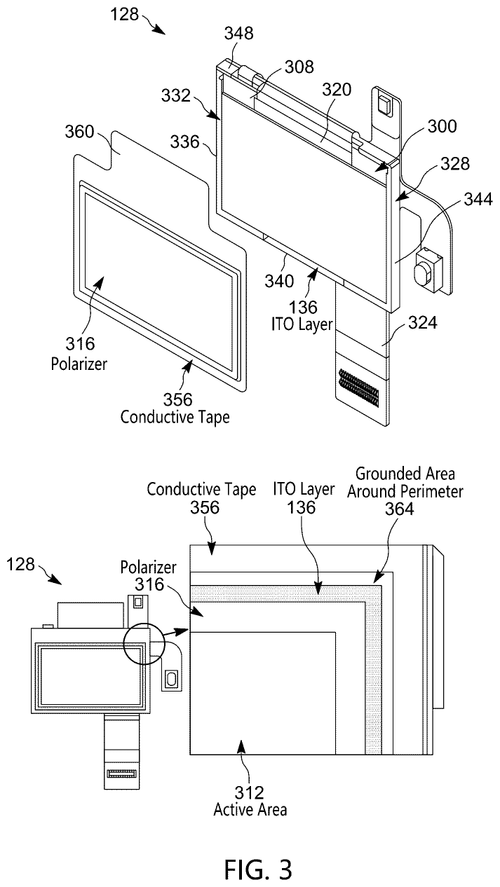

FIG. 2B illustrates the radio 100 including the display module 128, according to some examples. The display module 128 is connected to the controller 116 and grounded via the controller 116 at a ground contact 132. The display module 128 includes an indium tin oxide (ITO) layer 136 (FIGS. 3-6) connected to the ground contact 132. The ITO layer 136 shields and grounds the display module 128 to reduce RF noise emitted from the display module 128. In the illustrated example of FIG. 2B, the antenna 108 receives a radio signal 140 and the display module 128 generates RF noise 144. The ITO layer 136 shields the display module 128 and reduces an amount of the RF noise 144 that reaches the radio signal 140 received from the antenna 108. Based on the shielding from the ITO layer 136, the amount of the RF noise 144 is reduced below the receiver noise floor and the antenna 108 receives the radio signal 140 for the desired communication range.

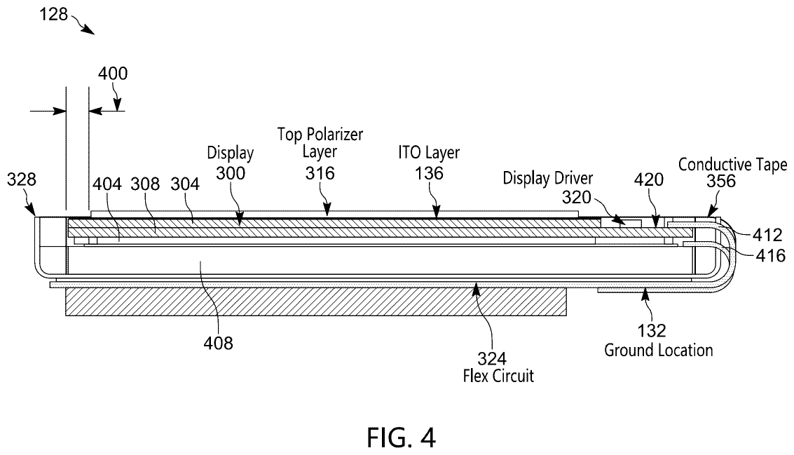

FIG. 3 illustrates the display module 128 for the radio 100 including the ITO layer 136, according to some examples. The display module 128 includes a display 300, for example, a liquid crystal display (LCD) having a front glass surface (e.g., display glass surface) 304 (FIG. 4). For simplicity, the LCD may be described herein as a display 300. The display 300 is configured to display information related to the operation of the radio 100. In some examples, at least a portion of the front glass surface 304 is viewable on the housing 104 such that information is displayed via the front glass surface 304. The display 300 may be a six-sided LCD having the front glass surface 304, a rear glass surface 308 opposite the front glass surface 304, a first side surface, a second side surface, a third side surface, and a fourth side surface. In the illustrated embodiment of FIG. 3, the ITO layer 136 is disposed on the front glass surface 304.

The ITO layer 136 is a transparent conducting film disposed on the front glass surface 304. As described above, the ITO layer 136 is grounded by the connection to the ground contact 132. The ITO layer 136 shields the display 300 and reduces RF noise emitted from an active area 312 of the display 300, or the portion of the front glass surface 304 viewable from the housing 104. The display module 128 also includes a top polarizer layer 316 disposed on the ITO layer 136. In some examples, the top polarizer layer 316 filters light waves output from the front glass surface 304. The top polarizer layer 316 is retracted (e.g., a length and a width of the top polarizer layer 316 is reduced) to form an exposed perimeter portion of the ITO layer 136. By disposing the ITO layer 136 between the front glass surface 304 and the top polarizer layer 316 and retracting the top polarizer layer 316, the ITO layer 136 shields the front glass surface 304 without adding thickness to the display module 128.

The display module 128 also includes a display driver 320 coupled to the rear glass surface 308 and a flexible circuit board (e.g., a flex circuit) 324 coupled to the display driver 320. In some examples, the flex circuit 324 includes the controller 116. The display driver 320 is a hardware component including software instructions that, when executed by the display driver 320 or the flex circuit 324, cause the display driver 320 or the flex circuit 324 to control, among other things, the display module 128.

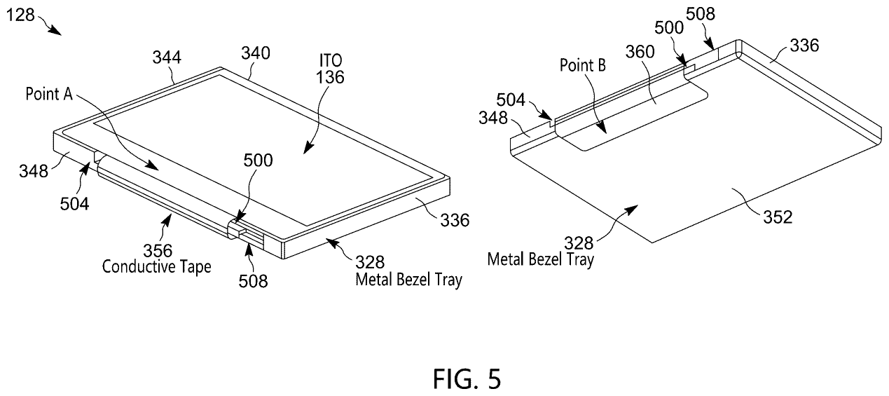

The display module 128 also includes a metal bezel tray 328 within which the display 300 is seated (e.g., positioned). The metal bezel tray 328 includes a top opening 332, and is formed of four metal sidewalls (e.g., a first metal sidewall 336, a second metal sidewall 340, a third metal sidewall 344, and a fourth metal sidewall 348), and a bottom metal surface 352 (FIG. 5). In some examples, the metal bezel tray 328 receives the display 300 via the top opening 332 such that the display 300 is seated within the metal bezel tray 328 with the front glass surface 304 facing the top opening 332.

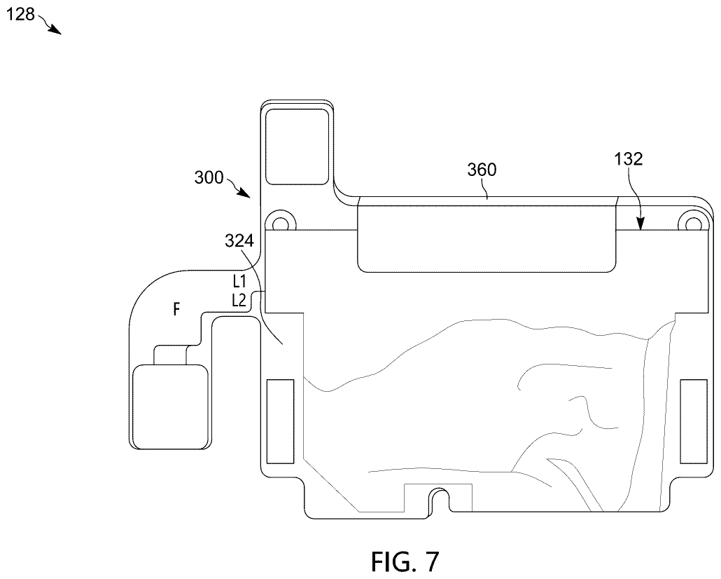

The display module 128 also includes a conductive adhesive tape (e.g., a conductive tape) 356 having a conductive tab 360 extending therefrom. In some examples, the conductive adhesive tape 356 and the conductive tab 360 are formed of a copper alloy. The conductive adhesive tape 356 adheres to the exposed perimeter portion of the ITO layer 136. The conductive adhesive tape 356 covers part of the exposed perimeter portion of the ITO layer 136 to form a grounded area 364 around the exposed perimeter portion. Accordingly, the ITO layer 136 is also grounded through the conductive adhesive tape 356. For simplicity of visual representation, in some illustrated examples, the conductive tab 360 wraps across one of the sides of the metal bezel tray 328 and adheres to the bottom metal surface 352 (FIG. 5) to cover the display 300. In operation, the conductive tab 360 wraps over the flex circuit 324 (and across one of the sides of the metal bezel tray 328) and connects (e.g., adheres) to the ground contact 132 on the flex circuit 324 (FIGS. 4 and 7). The flex circuit 324 is grounded (via the ground contact 132) to the metal bezel tray 328 on the bottom metal surface 352 using the conductive tab 360 (FIG. 4). The conductive adhesive tape 356 forms a ground (GND) shield around the ITO layer 136, the display driver 320, and the flex circuit 324. In other words, the conductive adhesive tape 356 adheres to the ITO layer 136 and the conductive tab 360 adheres to the flex circuit 324 such that the flex circuit 324 connects to the bottom metal surface 352 to shield the display module 128 in which the ITO layer 136 shields the front glass surface 304. The combination of the ITO layer 136 and the conductive adhesive tape 356 (including the conductive tab 360) reduces RF noise emitted by the display module 128 to a level that is below the receiver noise floor. In some examples, the ITO layer 136 and the conductive adhesive tape 356 form a Faraday cage around the display 300, the display driver 320, and the flex circuit 324 to reduce the RF noise emitted from the display module 128 that reaches the antenna 108.

FIG. 4 is a side view of the display module 128 for the radio 100 including the ITO layer 136 and the conductive adhesive tape 356, according to some examples. As shown in the illustrated example of FIG. 4, the display module 128 also includes the display 300, the front glass surface 304, the rear glass surface 308, the top polarizer layer 316, the display driver 320, the flex circuit 324, the metal bezel tray 328, and the ground contact 132. As described above, the top polarizer layer 316 is retracted such that the length and the width of the top polarizer layer 316 is reduced by a distance 400 to form the exposed perimeter portion of the ITO layer 136. The conductive adhesive tape 356 adheres to the exposed perimeter portion of the ITO layer 136.

The display module 128 also includes a bottom polarizer layer 404 and a light guide 408. The bottom polarizer layer 404 is disposed on the rear glass surface 308. The light guide 408 is coupled to the bottom polarizer layer 404. In some examples, the light guide 408 directs light waves toward the display 300 through the bottom polarizer layer 404. The bottom polarizer layer 404 filters the light waves output from the light guide 408 to the display 300 through the rear glass surface 308. The light waves pass through the rear glass surface 308 and the front glass surface 304 outputs the light waves to display information related to the radio 100, as described above.

The display module 128 also includes a driver flex circuit 412 and a light guide flex circuit 416. In some examples, the flex circuit 324 includes the driver flex circuit 412 and the light guide flex circuit 416. The driver flex circuit 412 couples the flex circuit 324 (e.g., the controller 116) to the display driver 320 through the metal bezel tray 328. The light guide flex circuit 416 couples the light guide 408 to the flex circuit 324 (e.g., the controller 116) through the metal bezel tray 328. The flex circuit 324 is coupled to the display driver 320 via the driver flex circuit 412 through the rear glass surface 308 using an anisotropic conductive film (ACF) 420.

As described above, the flex circuit 324 includes the ground contact 132. The ground contact 132 may also be referred to as a flex ground point of the flex circuit 324. The ground contact 132 is coupled to a radio chassis ground of the housing 104 to ground the radio 100. Referring back to the conductive adhesive tape 356, the conductive adhesive tape 356 (including the conductive tab 360) wraps around the flex circuit 324 and covers all sides of the display driver 320. By covering all sides of the display driver 320, the conductive adhesive tape 356 covers a top surface of the display driver 320 and a total area of the rear glass surface 308 where the display driver 320 is coupled.

FIG. 5 illustrates the display module 128 for the radio 100 including the ITO layer 136 and the conductive adhesive tape 356 positioned in the metal bezel tray 328, according to some examples. In some examples, the metal bezel tray 328 includes a side opening 500 in one of the sidewalls. In the illustrated example of FIG. 5, the metal bezel tray 328 includes the side opening 500 in the fourth metal sidewall 348. Although the side opening 500 is illustrated as being in the fourth metal sidewall 348, in some examples, the side opening 500 is in the first metal sidewall 336, the second metal sidewall 340, or the third metal sidewall 344.

As described above, for simplicity of visual representation, the conductive adhesive tape 356 adheres to the exposed perimeter portion of the ITO layer 136, for example, at Point A, as shown in FIG. 5. The conductive tab 360 wraps across the side opening 500 of the fourth metal sidewall 348 and adheres to the bottom metal surface 352, for example, at Point B, as shown in FIG. 5. As the conductive tab 360 adheres to the bottom metal surface 352, the conductive tab 360 forms (e.g., provides) a first gap 504 and a second gap 508 in the side opening 500. The flex circuit 324 protrudes through the first gap 504 to mate with the bottom metal surface 352.

Referring to FIGS. 4 and 5, the second gap 508 accommodates the light guide flex circuit 416 for coupling the light guide 408 to the flex circuit 324 through the metal bezel tray 328. In other words, the light guide flex circuit 416 couples the light guide 408 to the flex circuit 324 through the second gap 508. In some examples, the light guide flex circuit 416 is not shielded by the conductive adhesive tape 356. Similarly, the first gap 504 accommodates the driver flex circuit 412 for coupling the display driver 320 to the flex circuit 324. In other words, the driver flex circuit 412 couples the display driver 320 to the flex circuit 324 through the first gap 504. The first gap 504 and the second gap 508 are sized to block the RF noise emitted from the display 300 through the side opening 500. In other words, the conductive tab 360 wraps across the side opening 500 such that the first gap 504 and the second gap 508 are small enough to block the RF noise emitted from the display 300 to exit the side opening 500.

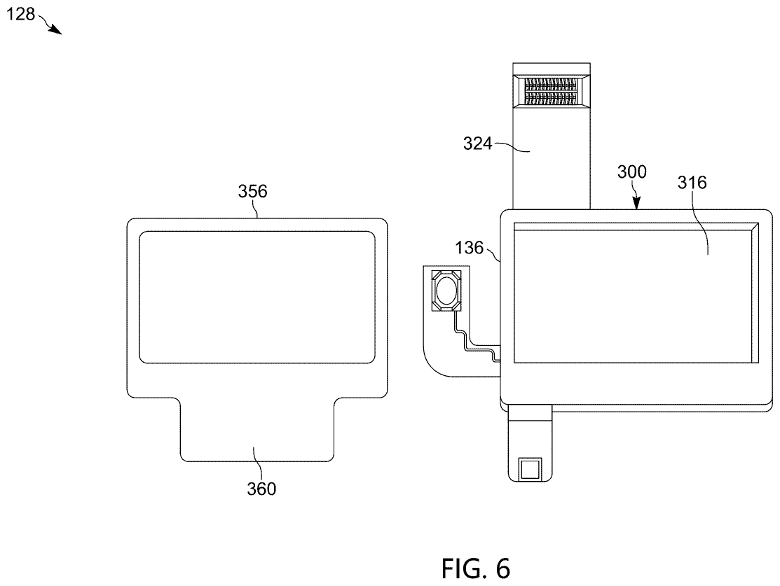

FIG. 6 illustrates the display module 128 for the radio 100 and the ITO layer 136 with the conductive adhesive tape 356 separate from the display module 128, according to some examples. In the illustrated example of FIG. 6, the display 300 is connected to and the flex circuit 324. The ITO layer 136 is disposed on the display 300. The top polarizer layer 316 is disposed on the ITO layer 136. For example, the ITO layer 136 is disposed on the front glass surface 304. The conductive adhesive tape 356 and the conductive tab 360 are separated from the display 300. As described above, the conductive adhesive tape 356 adheres to the exposed perimeter portion (e.g., a top perimeter) of the ITO layer 136. The conductive tab 360 wraps across the display 300 to form a shield around the display 300 to reduce the RF noise emitted from the display 300.

FIG. 7 illustrates the display module 128 for the radio 100 including the conductive adhesive tape 356 having the conductive tab 360 wrapping across the display 300, according to some examples. The conductive tab 360 wraps across the display 300 and the flex circuit 324 towards the rear of the display 300 where the conductive tab 360 adheres to the flex circuit 324 at the ground contact 132 (FIG. 4). The flex circuit 324 connects to the metal bezel tray 328.

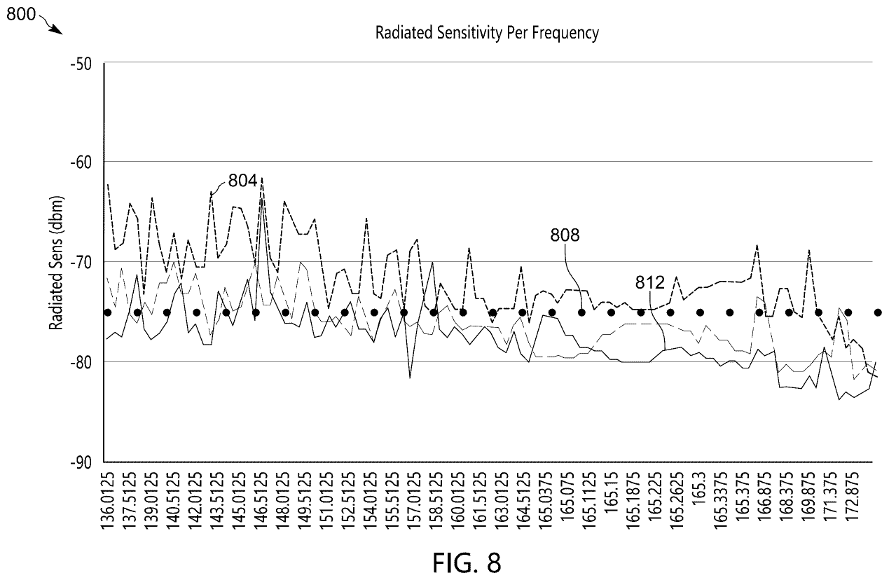

FIG. 8 is a graph 800 of radiated sensitivity over frequency for the radio 100, according to some examples. In some examples, the radiated sensitivity of the radio 100 is a range or coverage of the radio signal received by the radio 100. The graph 800 includes a line 804 showing a baseline radiated sensitivity for the radio 100 without the ITO layer 136 and the conductive adhesive tape 356. The graph 800 also includes a dotted line 808 showing a target radiated sensitivity level for the radio 100. For simplicity, the dotted line 808 may be considered the receiver noise floor where the RF noise from the display module 128 does not interfere with radio signals received from the antenna 108 if the RF noise is below the dotted line 808. As illustrated in the graph 800, the line 804 indicates that the radiated sensitivity is greater than the dotted line 808 for a majority of the graph 800. Accordingly, the RF noise from the display module 128 without the ITO layer 136 and the conductive adhesive tape 356 interferes with the radio signal received by the antenna 108.

The graph 800 also includes a line 812 showing a radiated sensitivity for the radio 100 including the ITO layer 136 and the conductive adhesive tape 356. The line 812 indicates that the ITO layer 136 and the conductive adhesive tape 356 improves the radiated sensitivity of the radio 100 to a level less than the dotted line 808. In other words, the ITO layer 136 and the conductive adhesive tape 356 reduce the RF noise emitted from the display to a leaked RF noise level below the receiver noise floor. In some examples, the ITO layer 136 and the conductive adhesive tape 356 reduce the leaked RF noise level of the RF noise below (e.g., to a level less than) a 0.18 microvolt root mean square (uVrms) radiated sensitivity level of the receiver in the radio transceiver 112, which is equivalent to a 7 mile line-of-sight coverage range for the radio 100. In some examples, the ITO layer 136 and the conductive adhesive tape 356 reduce the RF noise to a level of greater than 5 decibels (dB) below the thermal noise floor.

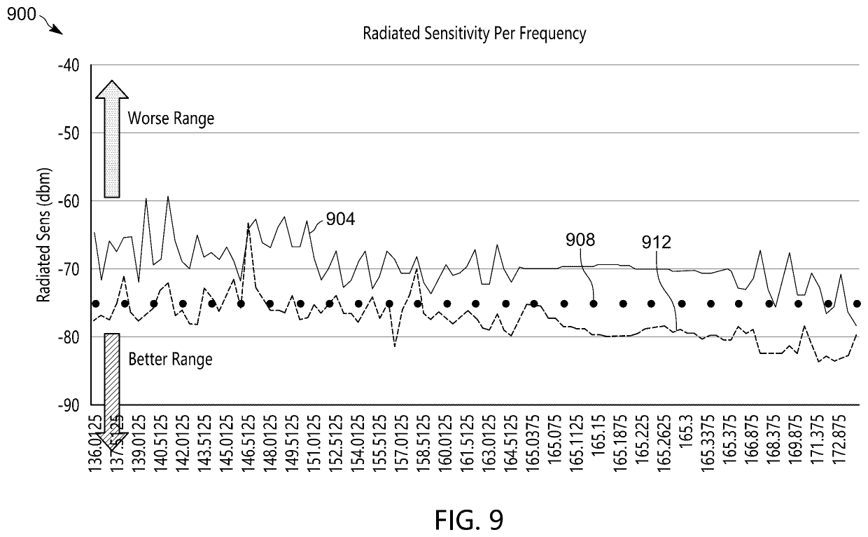

FIG. 9 is a graph 900 of radiated sensitivity over frequency for the radio 100, according to some examples. Similar to the graph 800, the graph 900 includes a line 904 showing a baseline radiated sensitivity for the radio 100 without the ITO layer 136 and the conductive adhesive tape 356. The graph 900 also includes a dotted line 908 showing a target radiated sensitivity level for the radio 100. As illustrated in the graph 900, the line 904 indicates that the radiated sensitivity is greater than the dotted line 908 for a majority of the graph 900. The graph 900 also includes a line 912 showing a radiated sensitivity for the radio 100 including the ITO layer 136 and the conductive adhesive tape 356. The line 912 indicates that the ITO layer 136 and the conductive adhesive tape 356 improves the radiated sensitivity of the radio 100 to a level less than the dotted line 908. In other words, the ITO layer 136 and the conductive

adhesive tape 356 reduce the RF noise emitted from the display to a leaked RF noise level below the receiver noise floor.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot transmit and receive radio signals, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,”

“including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should

not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A portable radio, comprising:
a housing having a display module, the display module generating radio frequency (RF) noise greater than a receiver noise floor within a very high frequency (VHF) radio band;
a controller and a VHF narrowband transceiver operating within the housing;
an external VHF antenna operatively coupled to the VHF narrowband transceiver, the VHF antenna being susceptible to interference from the RF noise that is greater than the receiver noise floor;
the display module comprising:
a liquid crystal display (LCD) having a front glass surface, wherein at least a portion of the front glass surface is viewable on the housing;
an indium tin oxide (ITO) layer disposed on the front glass surface;
a top polarizer layer disposed on the ITO layer, the top polarizer being retracted to form an exposed perimeter portion of the ITO layer;
a display driver coupled to a rear glass surface of the LCD;
a metal bezel tray within which the LCD is seated, the metal bezel tray including a top opening and being formed of four metal sidewalls, and a bottom metal surface, the metal bezel tray having a side opening in one of the sidewalls;
a flex circuit coupled to the display driver, the flex circuit having a flex ground point, the flex ground point being coupled to a radio chassis ground of the portable radio; and
a conductive adhesive tape adhered to the exposed perimeter portion of the ITO layer, the conductive adhesive tape covering all sides of the display driver, the conductive adhesive tape having a conductive tab extending therefrom, the conductive tab wrapping across the side opening of the metal bezel and adhering to the bottom metal surface of the metal bezel, the conductive tab providing a first gap and a second gap, the flex circuit protruding through the first gap to mate with the bottom metal surface of the metal bezel, the ITO layer being grounded through the conductive adhesive tape;
wherein the conductive adhesive tape forms a ground (GND) shield around the ITO layer, the display driver, and the flex circuit.

2. The portable radio of claim 1, wherein the ITO layer and the conductive adhesive tape reduce the RF noise below the receiver noise floor.

3. The portable radio of claim 1, wherein the VHF antenna and the VHF narrowband transceiver operate in a VHF radio band of 136-174 megahertz (MHz).

4. The portable radio of claim 1, wherein the second gap accommodates a light guide flex circuit for coupling a light guide of the display module to the controller.

5. The portable radio of claim 1, wherein the first gap accommodates a driver flex circuit for coupling the flex circuit of the display module to the display driver.

6. The portable radio of claim 1, wherein the ITO layer and the conductive adhesive tape reduce a leaked RF noise level from the display module below a 0.18 uVrms radiated sensitivity level of the VHF narrowband transceiver, equivalent to a 7 mile line-of-sight coverage range.

7. The portable radio of claim 1, wherein the ITO layer and the conductive adhesive tape reduce the RF noise to a level of greater than 5 decibels (dB) below the receiver noise floor.

8. The portable radio of claim 1, wherein the first gap and the second gap are sized to block the RF noise through the side opening of the metal bezel tray.

9. The portable radio of claim 1, wherein the ITO layer is transparent such that the front glass surface is viewable on the housing.

10. The portable radio of claim 1, wherein the flex circuit is coupled to the display driver through the rear glass surface using an anisotropic conductive film (ACF).

11. The portable radio of claim 10, wherein the conductive adhesive tape covering all sides of the display driver includes the conductive adhesive tape covering a top surface of the display driver and a total area of the rear glass surface where the display driver is coupled.

12. The portable radio of claim 1, wherein the LCD is a six-sided LCD having the front glass surface, the rear glass surface, a first side surface, a second side surface, a third side surface, and a fourth side surface.

13. The portable radio of claim 1, wherein the display module further comprises:
a bottom polarizer layer disposed on the rear glass surface; and
a light guide coupled to the bottom polarizer layer.

14. A portable radio, comprising:
a housing having a controller and a very high frequency (VHF) transceiver operating within the housing;
a VHF antenna coupled to the housing and communicatively connected to the VHF transceiver;
a display emitting radio frequency (RF) noise greater than a receiver noise floor within a VHF radio band that interferes with a radio signal of the VHF antenna, the display comprising:
a display glass surface viewable on the housing;
an indium tin oxide (ITO) layer disposed on the display glass surface;
a metal bezel tray within which the display glass surface is positioned, the metal bezel tray having a top opening, four sides, and a bottom surface, the metal bezel tray having a side opening in one of the four sides;
a flex circuit coupled to a display driver, the flex circuit having a ground contact, the ground contact connected to the bottom surface and being coupled to a radio chassis ground of the portable radio; and
a conductive tape disposed on a top perimeter of the ITO layer, the conductive tape wrapping across the side opening and coupled to the bottom surface to form a gap between the bottom surface and the conductive tape, the ITO layer being grounded through the conductive tape, the conductive tape and the ITO layer form a shield around the display to reduce the RF noise emitted from the display.

15. The portable radio of claim 14, wherein the ITO layer and the conductive tape reduce the RF noise below the receiver noise floor.

16. The portable radio of claim 14, wherein the VHF antenna and the VHF transceiver operate in a VHF radio band of 136-174 megahertz (MHz).

17. The portable radio of claim 14, wherein the ITO layer and the conductive tape reduce a leaked RF noise level from the display below a 0.18 uVrms radiated sensitivity level of the VHF transceiver, equivalent to a 7 mile line-of-sight coverage range.

18. The portable radio of claim 14, wherein the ITO layer and the conductive tape reduce the RF noise to a level of greater than 5 decibels (dB) below the receiver noise floor.

19. The portable radio of claim 14, wherein the gap includes a first gap and a second gap, the first gap and the second gap are sized to block the RF noise through the side opening of the metal bezel tray.

20. The portable radio of claim 14, wherein the ITO layer is transparent such that the display glass surface is viewable on the housing.
